(19) United States
(12) Patent Application Publication
(10) Pub. No.: US 2026/0136170 A1
(43) Pub. Date: May 14, 2026

(54) METHOD AND APPARATUS FOR DETERMINING MOVEMENT

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/115,510

(22) PCT Filed: Sep. 29, 2022
(86) PCT No.: PCT/CN2022/122938

§ 371 Date: Mar. 26, 2025

(51) Int. Cl. H04W 8/02

(52) U.S. Cl. CPC H04W 8/02

(57) ABSTRACT

A method and system for determining movement of a terminal device relative to an integrated access and backhaul (IAB) node is disclosed. The method includes obtaining first information related to the terminal device and determining, based on the first information and second information of the IAB-node, whether the terminal device is moving together with the IAB-node. The first information includes at least one or more of location, speed, or direction information of the terminal device. The second information includes corresponding location, speed, or direction data of the IAB-node and relevant threshold information. The invention also includes implementations on a communication device and a computer-readable storage medium. The disclosed solution enables improved movement detection between terminal devices and mobile IAB-nodes, enhancing mobility management in wireless networks.

### CROSS-REFERENCE TO RELATED APPLICATIONS

The present application is a U.S. National Stage of International Application No. PCT/CN 2022/122938, filed on PCT Sep. 29, 2022, the contents of all of which are incorporated herein by reference in their entireties for all purposes.

### BACKGROUND OF THE INVENTION

At present, in a New Radio (NR) system, integrated access and backhaul (IAB) supports millimeter-wave base stations for wireless access and backhaul, which can effectively reduce the demand for deployment of new optical fiber when deploying a dense network, making wireless relay in NG-RAN (NG radio access network) possible. The relay node is referred to as an IAB-node, which supports wireless access and backhaul via NR. The terminate node at the network side for NR backhaul is referred to as an IAB-donor, which is a gNB (a base station of 5G network) with IAB functions attached. The backhaul can be done via a single hop or a plurality of hops.

In the subject study of IAB of Release 18, scenarios of mobile IAB are supported, and the study work of mobile IAB focuses on scenarios where an on-board mobile IAB-node provides 5G coverage or enhanced capability for an on-board and/or surrounding terminal. Terminal devices served under the mobile IAB-node can be classified into on-board UEs and surrounding UEs. The on-board UEs can be understood as terminal devices that move together with the IAB-node.

### SUMMARY OF THE INVENTION

The present disclosure relates to the technical field of communications, and in particular relates to a method and device for determining movement

In a first aspect, an embodiment of the present disclosure provides a method for determining movement. The method is performed by a terminal device and includes:
obtaining first information of the terminal device; and
judging, according to the first information of the terminal device and second information of an integrated access and backhaul (IAB)-node, whether the terminal device moves together with the IAB-node.

In a second aspect, an embodiment of the present disclosure provides another method for determining movement. The method is performed by an integrated access and backhaul (IAB)-donor and includes:
transmitting configuration information to a terminal device, where the configuration information is used to assist the terminal device in judging whether the terminal device moves together with an IAB-node.

In a third aspect, an embodiment of the present disclosure provides a communication device including one or more processors, which, when invoking a computer program in a memory, perform the method according to the first aspect.

In a fourth aspect, an embodiment of the present disclosure provides a communication device including one or more processors, which, when invoking a computer program in a memory, perform the method according to the second aspect.

In a fifth aspect, an embodiment of the present disclosure provides a communication device including one or more processors and a memory, where the memory stores a computer program; the one or more processors are collectively configured to execute the computer program stored on the memory to cause the communication device to perform the method according to the first aspect.

In a sixth aspect, an embodiment of the present disclosure provides a communication device including one or more processors and a memory, where the memory stores a computer program; the one or more processors are collectively configured to execute the computer program stored on the memory to cause the communication device to perform the method according to the second aspect.

In a seventh aspect, an embodiment of the present disclosure provides a system for determining movement. The system includes the communication device according to the third aspect and the communication device according to the fourth aspect, or the system includes the communication device according to the fifth aspect and the communication device according to the sixth aspect.

In an eighth aspect, an embodiment of the present disclosure provides a non-transitory computer-readable storage medium for storing instructions for use in the above terminal device, where the instructions, when executed, cause the terminal device to perform the method according to the first aspect.

In a ninth aspect, an embodiment of the present disclosure provides a non-transitory computer-readable storage medium for storing instructions for use in the above network device, where the instructions, when executed, cause the network device to perform the method according to the second aspect.

In a tenth aspect, the present disclosure further provides a computer program product including a computer program. The computer program product, when running on a computer, causes the computer to perform the method according to the first aspect.

In an eleventh aspect, the present disclosure further provides a computer program product including a computer program. The computer program product, when running on a computer, causes the computer to perform the method according to the second aspect.

In a twelfth aspect, the present disclosure provides a computer program which, when running on a computer, causes the computer to perform the method according to the first aspect.

In a thirteenth aspect, the present disclosure provides a computer program which, when running on a computer, causes the computer to perform the method according to the second aspect.

### BRIEF DESCRIPTION OF DRAWINGS

In order to illustrate the technical solution in the embodiments of the present disclosure or the background art more clearly, the accompanying drawings needed to be used in the embodiments of the present disclosure or the background art will be illustrated below.

FIG. 1A is a first example diagram of an integrated access and backhaul (IAB) architecture provided by an embodiment of the present disclosure;

FIG. 1B is a second example diagram of the integrated access and backhaul (IAB) architecture provided by an embodiment of the present disclosure;

FIG. 2 is a schematic flowchart of a method for determining movement provided by an embodiment of the present disclosure;

FIG. 3 is a schematic flowchart of a method for determining movement provided by another embodiment of the present disclosure;

FIG. 4 is a schematic flowchart of a method for determining movement provided by yet another embodiment of the present disclosure;

FIG. 5 is a schematic structural diagram of a communication device provided by an embodiment of the present disclosure; and

FIG. 6 is a schematic structural diagram of a communication device provided by another embodiment of the present disclosure.

### DETAILED DESCRIPTION OF THE INVENTION

In the following, the embodiments of the present disclosure are described in detail, the examples of which are shown in the accompanying drawings, in which like or similar reference numerals represent like or similar elements or elements having like or similar functions throughout the disclosure. The embodiments as described below with reference to the accompanying drawings are illustrative and are intended to explain the present disclosure, and cannot be construed as limiting the present disclosure. In the description of the present disclosure, unless otherwise stated, “/” refers to “or”. For example, A/B can refer to A or B. Here, “and/or” is a kind of associating relationship that describes associated objects, which means that there can be three kinds of relationships. For example, A and/or B can refer to three situations: there is A alone, there are both A and B, and there is B alone.

The terms as used in the embodiments of the present disclosure are for the purpose of describing specific embodiments, and are not intended to limit the embodiments of the present disclosure. The singular forms “a,” “an” and “the” as used in the embodiments of the present disclosure and the appended claims are also intended to include the plural forms, unless otherwise clearly indicated in the context.

It is to be understood that although the terms “first,” “second,” “third,” etc. may be used to describe various information in the embodiments of the present disclosure, such information should not be limited to these terms. These terms are used to distinguish between the same type of information. For example, without departing from the scope of the embodiments of the present disclosure, first information can be referred to as second information, and similarly, second information can be referred to as first information. Depending on the context, the words “in a case where” and “if” as used here can be explained as “while . . . ” or “when . . . ” or “in response to determining that”.

In the following, the embodiments of the present disclosure are described in detail, the examples of which are shown in the accompanying drawings, in which like or similar reference numerals represent like or similar elements throughout the disclosure. The embodiments as described below with reference to the accompanying drawings are exemplary and are intended to explain the present disclosure, and cannot be construed as limiting the present disclosure.

At present, in a New Radio (NR) system, integrated access and backhaul (IAB) supports millimeter-wave base stations for wireless access and backhaul, which can effectively reduce the demand for deployment of new optical fiber when deploying a dense network, making wireless relay in NG-RAN (NG radio access network) possible. Here, the relay node is referred to as an IAB-node, which supports wireless access and backhaul via NR. The terminate node at the network side for NR backhaul is referred to as an IAB-donor, which is a gNB (a base station of 5G network) with IAB functions attached. The backhaul can be done via a single hop or a plurality of hops.

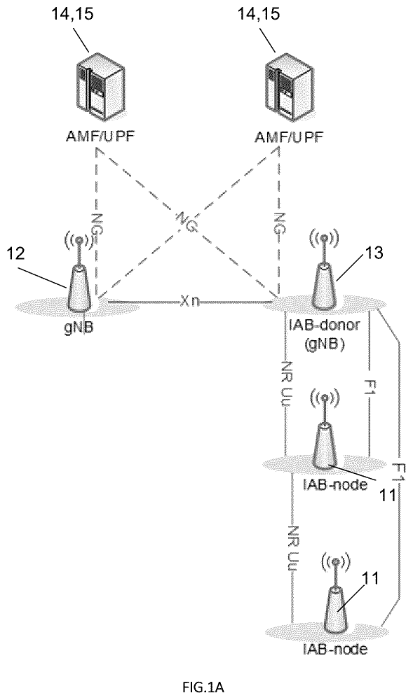

As shown in FIGS. 1A and 1B, the NG-RAN 10 supports IAB by wirelessly connecting an IAB-node 11 to a gNB 12 (referred to as an IAB-donor 13) capable of serving the IAB-node. The IAB-donor 13 includes one IAB-donor-CU 131 (central unit) and one or more IAB-donor-DUs 132 (distributed units). When a gNB-CU-CP (central unit-control plane) and a gNB-CU-UP (central unit-user plane) are separated, the IAB-donor 13 may include one IAB-donor-CU-CP, a plurality of IAB-donor-CU-Ups, and a plurality of IAB-donor-Dus 132. The IAB-node 11 is connected to an upstream IAB-node or IAB-donor-DU 132 through a terminal function subset of an NR Uu interface (referred to as an IAB-MT function in the IAB-node 11). The IAB-node 11 provides wireless backhaul to a downstream IAB-node 11 and a terminal device through a network function of the NR Uu interface (referred to as an IAB-DU function of the IAB-node 11). The AMF 14 in FIG. 1A, which is the abbreviation of Access and Mobility Management Function, refers to an access and mobility management function in Chinese. The UPF 15 in FIG. 1A, which is the abbreviation of User Plane Function, refers to a user plane function in Chinese.

An F1-C service between the IAB-node and the IAB-donor-CU is subjected to backhaul through the IAB-donor-DU and an optional intermediate hop IAB-node. An F1-U service between the IAB-node and the IAB-donor-CU is subjected to backhaul through the IAB-donor-DU and an optional intermediate hop IAB-node.

In the subject study of IAB of Release 18, scenarios of mobile IAB are supported, and the study work of mobile IAB focuses on scenarios where an on-board mobile IAB-node provides 5G coverage or enhanced capability for an on-board and/or surrounding terminal. Terminal devices served under the mobile IAB-node can be classified into on-board UEs and surrounding UEs. The on-board terminal, that is, the terminal that moves together with the IAB-node, can preferentially access the IAB-node that moves together with the terminal.

However, there is still a lack of effective means at present to determine a terminal device that moves together with an IAB-node.

To this regard, The embodiments of the present disclosure provide a method and device for determining movement, which can be applied to a 5G system, is suitable for a scenario where mobile integrated access and backhaul (IAB) is supported, and can solve the problem of how to judge, during the movement of a mobile IAB-node, whether a terminal device moves together with the IAB, so that the terminal device that moves together with the IAB-node can preferentially access the IAB-node.

A detailed introduction is made below in conjunction with the accompanying drawings to the method and device for determining movement as provided by the present disclosure.

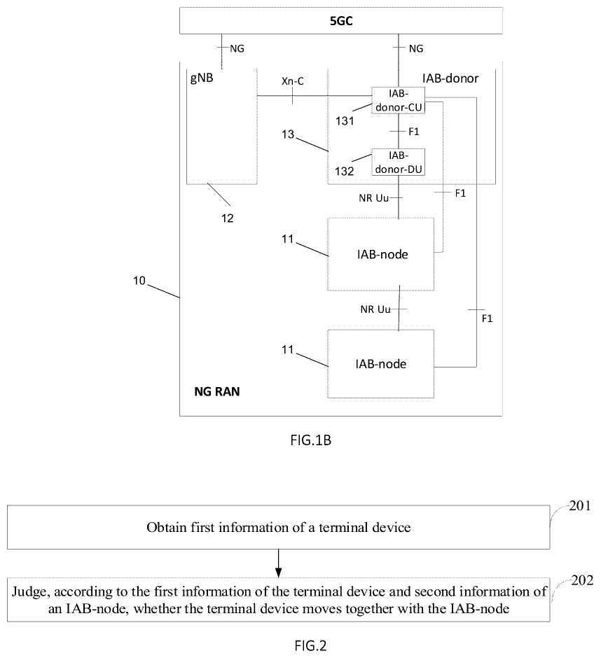

Reference is made to FIG. 2, which is a schematic flowchart of a method for determining movement provided by an embodiment of the present disclosure. It is to be noted that a terminal device can determine movement in the embodiment of the present disclosure. As shown in FIG. 2, the method may include but is not limited to the following steps.

In step 201, first information of the terminal device is obtained.

In an embodiment of the present disclosure, the first information of the terminal device may include but is not limited to at least two of first location information of the terminal device, first speed information of the terminal device, or first direction information of the terminal device.

In some examples, the terminal device may obtain its own first information, which may include but is not limited to at least two of the first location information, the first speed information, or the first direction information. The first location information of the terminal device can be understood as the location information of the terminal device, such as longitude and latitude information, or geographic location information in other formats, etc. The first speed information of the terminal device can be understood as the speed information of the terminal device. The first direction information of the terminal device can be understood as the direction information of the terminal device.

In a possible implementation, the terminal device may obtain the first location information and the first speed information of the terminal device.

In another possible implementation, the terminal device may obtain the first location information and the first direction information of the terminal device.

In another possible implementation, the terminal device may obtain the first speed information and the first direction information of the terminal device.

In yet another possible implementation, the terminal device may obtain the first location information, the first speed information and the first direction information of the terminal device.

In some embodiments of the present disclosure, the terminal device may obtain its own location information and/or direction information according to a positioning module. As an example, the positioning module can be a GPS (Global Positioning System). In some examples, the terminal device may also obtain its own location information and/or direction information in other means, which will not be repeated here.

In some embodiments of the present disclosure, the terminal device may evaluate its own speed to obtain the speed information of the terminal device. In an implementation, the terminal device may determine the speed information of the terminal device with the number of times for which cell handover/reselection are performed for a period of time. In some examples, the terminal device may also obtain its own speed information in other means, such as obtaining the speed information of the terminal device with an acceleration sensor and/or a gyro sensor, etc. on the terminal device, which will not be repeated here.

It is to be noted that the terminal device in the embodiment of the present disclosure is an entity at the user side for receiving or transmitting signals, such as a mobile phone. The terminal device can also be referred to as a terminal, a user equipment (UE), a mobile station (MS), a mobile terminal device (MT), etc. The terminal device can be an automobile with communication functions, a smart automobile, a mobile phone, a wearable device, a Pad, a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form as employed by the terminal device are not limited by the embodiments of the present disclosure.

In step 202, it is judged, according to the first information of the terminal device and second information of an IAB-node, whether the terminal device moves together with the IAB-node.

In some embodiments of the present disclosure, if the terminal device moves together with the IAB-node, the terminal device can be referred to as an on-board terminal. The IAB-node is a mobile IAB-node. That is, the on-board terminal can be a terminal that moves together with the mobile IAB-node, and the mobile IAB-node can be a node that supports wireless access and backhaul via NR.

In a possible implementation, the terminal device may judge, according to at least two of the first location information, the first speed information or the first direction information of its own, whether the terminal device moves together with the IAB-node. For example, the terminal device may determine, according to its own first information and the second information of the IAB-node, whether the terminal device moves together with the IAB-node. Determining whether the terminal device moves together with the IAB-node can be understood as: whether the terminal device and the IAB-node move together. In some examples, the second information of the IAB-node can be understood as at least two of second location information, second speed information or second direction information of the IAB-node. In an implementation, the second information of the IAB-node may be transmitted by the IAB-node to the terminal device, so that the terminal device may determine, according to its own first information and the second information of the IAB-node, whether the terminal device moves together with the IAB-node. In another implementation, the second information of the IAB-node may be determined according to configuration information configured by an IAB-donor to the terminal device, so that the terminal device may determine, according to its own first information and the information configured by the IAB-donor (including the second information of the IAB-node), whether the terminal device moves together with the IAB-node.

As an example of a possible implementation, taking the first information including the first location information and the first speed information, and the second information including the second location information and the second speed information an example, the terminal device may determine, according to the first location information and the first speed information of the terminal device as well as the second location information and the second speed information of the IAB-node, whether the terminal device moves together with the IAB-node.

As another example of a possible implementation, taking the first information including the first location information and the first direction information, and the second information including the second location information and the second direction information an example, the terminal device may determine, according to the first location information and the first direction information of the terminal device as well as the second location information and the second direction information of the IAB-node, whether the terminal device moves together with the IAB-node.

As another example of a possible implementation, taking the first information including the first speed information and the first direction information, and the second information including the second speed information and the second direction information an example, the terminal device may determine, according to the first speed information and first direction information of the terminal device as well as the second speed information and second direction information of the IAB-node, whether the terminal device moves together with the IAB-node.

As yet another example of a possible implementation, taking the first information including the first location information, the first speed information and the first direction information, and the second information including the second location information, the second speed information and the second direction information an example, the terminal device may determine, according to the first location information, the first speed information and the first direction information of the terminal device as well as the second location information, the second speed information and the second direction information of the IAB-node, whether the terminal device moves together with the IAB-node.

In some examples, in some embodiments of the present disclosure, the terminal device may also determine, according to the first information and the configuration information configured by the IAB-donor (which may include information related to at least two of location, speed or direction, as well as threshold information), whether the terminal device moves together with the IAB-node. The IAB-donor can be a network device (such as gNB) with IAB functions.

By implementing the embodiments of the present disclosure, by determining, by a terminal device according to its own first information and second information of an IAB-node, whether the terminal device moves together with the IAB-node, the problem of how to judge, during the movement of the IAB-node, whether the terminal device moves together with the IAB-node can be solved, so that the terminal device that moves together with the IAB-node can preferentially access the IAB-node, guaranteeing the normal communication of the terminal device.

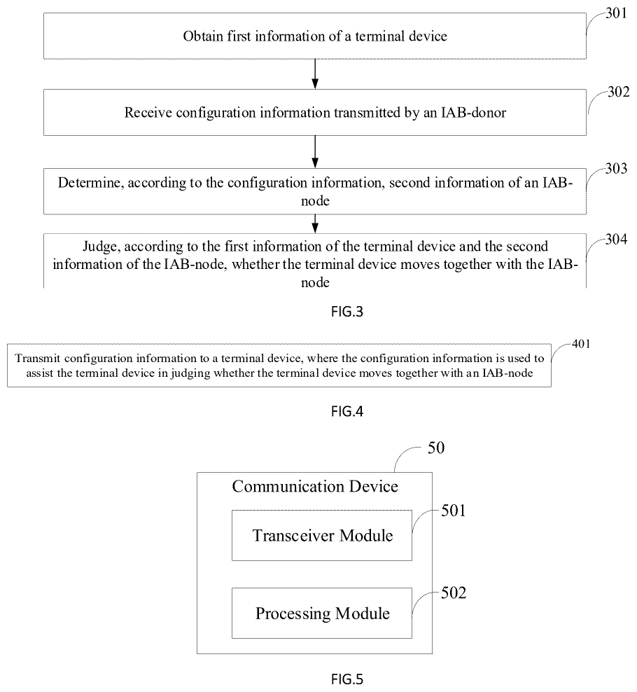

Reference is made to FIG. 3, which is a schematic flowchart of a method for determining movement provided by another embodiment of the present disclosure. It is to be noted that the method for determining movement in the embodiment of the present disclosure can be performed by a terminal device. As shown in FIG. 3, the method may include but is not limited to the following steps.

In step 301, first information of the terminal device is obtained.

In an embodiment of the present disclosure, step 301 can be implemented in any means of various embodiments of the present disclosure, respectively, which is not limited by the embodiments of the present disclosure, and will not be repeated.

In step 302, configuration information transmitted by an IAB-donor is received.

In an implementation, the terminal device may receive the configuration information transmitted by the IAB-donor via dedicated radio resource control (RRC) signaling or a system message. As an example, in a case where the terminal device is in an IDLE/INACTIVE state, the terminal device may receive the configuration information transmitted by the IAB-donor via the system message. Another example is when the terminal device is in a CONNECTED state, it may receive the configuration information transmitted by the IAB-donor via the system message or dedicated RRC signaling. For example, in a case where the dedicated RRC signaling is configured in the protocol standard, if the terminal is in the CONNECTED state, the terminal device may receive the configuration information transmitted by the IAB-donor via the dedicated RRC signaling. For another example, in a case where the dedicated RRC signaling is not configured in the protocol standard, if the terminal is in the CONNECTED state, the terminal device may receive the configuration information transmitted by the IAB-donor via the system message.

In some examples, the configuration information may include information related to at least two of location, speed or direction. As an example, the configuration information may be configuration information related to the position evaluation information and the speed evaluation information of an IAB-node. In some embodiments of the present disclosure, the configuration information may include but is not limited to at least one of: second location information of the IAB-node; location threshold information; second speed information of the IAB-node; speed threshold information; second direction information of the IAB-node; direction threshold information; or an evaluation time. The second location information of the IAB-node can be understood as the location information of the IAB-node. The second location information may be longitude and latitude information, or geographic location information in other formats, etc. As an example, the second location information, the second speed information and the second direction information of the IAB-node in the configuration information may be transmitted by the IAB-node to the IAB-donor. Or, the IAB-donor may also obtain the second location information, the second speed information and the second direction information of the IAB-node in other means, so that the terminal device may be configured with the second location information, the second speed information and the second direction information of the IAB-node, to assist the terminal device in judging whether the terminal device moves together with the IAB-node, which is not specifically limited by the present disclosure, and will not be repeated.

In some examples, the second speed information of the IAB-node can be understood as the speed information of the IAB-node, and the second direction information of the IAB-node can be understood as the direction information of the IAB-node.

In a possible implementation, the configuration information may include the second location information of the IAB-node, the location threshold information, the second speed information of the IAB-node and the speed threshold information.

In a possible implementation, the configuration information may include the second location information of the IAB-node, the location threshold information, the second direction information of the IAB-node and the direction threshold information.

In a possible implementation, the configuration information may include the second speed information of the IAB-node, the speed threshold information, the second direction information of the IAB-node and the direction threshold information.

In a possible implementation, the configuration information may include the second location information of the IAB-node, the location threshold information, the second speed information of the IAB-node, the speed threshold information, the second direction information of the IAB-node and the direction threshold information.

In a possible implementation, the configuration information may include the second location information of the IAB-node, the location threshold information, the second speed information of the IAB-node, the speed threshold information and the first evaluation time.

In a possible implementation, the configuration information may include the second location information of the IAB-node, the location threshold information, the second direction information of the IAB-node, the direction threshold information and the second evaluation time.

In a possible implementation, the configuration information may include the second speed information of the IAB-node, the speed threshold information, the second direction information of the IAB-node, the direction threshold information and the third evaluation time.

In a possible implementation, the configuration information may include the second location information of the IAB-node, the location threshold information, the second speed information of the IAB-node, the speed threshold information, the second direction information of the IAB-node, the direction threshold information and the evaluation time. The evaluation time includes a first evaluation time, a second evaluation time, a third evaluation time and a fourth evaluation time.

In an embodiment of the present disclosure, the second location information may be second longitude and latitude information or second geographic location information. In a possible implementation, the second location information is the second longitude and latitude information, and the location threshold information includes at least one of a longitude offset threshold, a latitude offset threshold, a longitude offset lag, or a latitude offset lag. In another possible implementation, the second location information is the second geographic location information, and the location threshold information includes at least one of a geographic location offset threshold or a geographic location offset lag.

In a possible implementation, the longitude offset threshold is the same as the latitude offset threshold, or the longitude offset threshold is different from the latitude offset threshold. In another possible implementation, the longitude offset lag is the same as the latitude offset lag, or the longitude offset lag is different from the latitude offset lag.

In an embodiment of the present disclosure, the speed threshold information may include at least one of: a speed offset threshold; or a speed offset lag.

In an embodiment of the present disclosure, the direction threshold information includes at least one of: a direction angle offset threshold; or a direction angle offset lag.

It is to be noted that in the embodiments of the present disclosure, the execution order of the above steps 301 and 302 are not specifically limited by the present disclosure. In some examples, step 301 can be executed before step 302, or step 302 can be executed before step 301, or step 301 and step 302 can be executed at the same time.

In step 303, second information of an IAB-node is determined according to the configuration information.

In a possible implementation, the configuration information may include the second location information of the IAB-node, the location threshold information, the second speed information of the IAB-node and the speed threshold information. The terminal device may determine, according to the configuration information, that the second information of the IAB-node includes the second location information and the second speed information.

In a possible implementation, the configuration information may include the second location information of the IAB-node, the location threshold information, the second direction information of the IAB-node and the direction threshold information. The terminal device may determine, according to the configuration information, that the second information of the IAB-node includes the second location information and the second direction information.

In a possible implementation, the configuration information may include the second speed information of the IAB-node, the speed threshold information, the second direction information of the IAB-node and the direction threshold information. The terminal device may determine, according to the configuration information, that the second information of the IAB-node includes the second speed information and the second direction information.

In a possible implementation, the configuration information may include the second location information of the IAB-node, the location threshold information, the second speed information of the IAB-node, the speed threshold information, the second direction information of the IAB-node and the direction threshold information. The terminal device may determine, according to the configuration information, that the second information of the IAB-node includes the second location information, the second speed information and the second direction information.

In a possible implementation, the configuration information may include the second location information of the IAB-node, the location threshold information, the second speed information of the IAB-node, the speed threshold information and the first evaluation time of the IAB-node. The terminal device may determine, according to the configuration information, that the second information of the IAB-node includes the second location information and the second speed information.

In a possible implementation, the configuration information may include the second location information of the IAB-node, the location threshold information, the second direction information of the IAB-node, the direction threshold information and the second evaluation time. The terminal device may determine, according to the configuration information, that the second information of the IAB-node includes the second location information and the second direction information.

In a possible implementation, the configuration information may include the second speed information of the IAB-node, the speed threshold information, the second direction information of the IAB-node, the direction threshold information and the third evaluation time. The terminal device may determine, according to the configuration information, that the second information of the IAB-node includes the second speed information and the second direction information.

In a possible implementation, the configuration information may include the second location information of the IAB-node, the location threshold information, the second speed information of the IAB-node, the speed threshold information, the second direction information of the IAB-node, the direction threshold information and the evaluation time, the evaluation time includes a first evaluation time, a second evaluation time, a third evaluation time and a fourth evaluation time. The terminal device may determine, according to the configuration information, that the second information of the IAB-node includes the second location information, the second speed information and the second direction information.

In step 304, it is judged, according to the first information of the terminal device and the second information of the IAB-node, whether the terminal device moves together with the IAB-node.

In this embodiment, the terminal device can determine, with its own location information and speed information, as well as the location information and the speed information of the IAB-node, whether the terminal device moves together with the IAB-node.

In this embodiment, the terminal device can determine, with its own location information and direction information, as well as the location information and the direction information of the IAB-node, whether the terminal device moves together with the IAB-node.

In this embodiment, the terminal device can determine, with its own speed information and direction information, as well as the speed information and the direction information of the IAB-node, whether the terminal device moves together with the IAB-node.

In this embodiment, the terminal device can determine, with its own location information, speed information and direction information, as well as the location information, the speed information and the direction information of the IAB-node, whether the terminal device moves together with the IAB-node.

It is to be noted that the above embodiments are not exhaustive, but schematic for part of the embodiments, and the above embodiments can be implemented separately, or in combination of a plurality of embodiments. The above embodiments are schematic, rather than specific limitations on the scope of protection of the embodiments of the present disclosure.

It is worth noting that the content that the configuration information transmitted by the IAB-donor to the terminal device specific includes, as well as the judging condition for judging whether the terminal device moves together with the IAB-node, may be determined according to a protocol or the actual application situation. Examples of several embodiments are given below to describe in detail the implementation of judging whether the terminal device moves together with the IAB-node.

In some embodiments of the present disclosure, the first information may include the first location information and the first speed information, and the configuration information may include the second location information of the IAB-node, location threshold information, the second speed information of the IAB-node, and speed threshold information. In an embodiment of the present disclosure, a possible implementation of judging, according to the first information of the terminal device and the second information of the IAB-node, whether the terminal device moves together with the IAB-node is as follows: determining, in response to determining that the first location information, the second location information and the location threshold information satisfy a first condition and that the first speed information, the second speed information and the speed threshold information satisfy a second condition, that the terminal device moves together with the IAB-node.

For example, the terminal device determines that the first location information, the second location information and the location threshold information satisfy the first condition and that the first speed information, the second speed information and the speed threshold information satisfy the second condition, then it may be determined that the terminal device moves together with the IAB-node. For another example, the terminal device determines that the first location information, the second location information and the location threshold information do not satisfy the first condition, and/or that the first speed information, the second speed information and the speed threshold information do not satisfy the second condition, then it may be determined that the terminal device does not move together with the IAB-node.

In an embodiment of the present disclosure, the first location information is first longitude and latitude information, the second location information is second longitude and latitude information, and the location threshold information includes at least one of a longitude offset threshold, a latitude offset threshold, a longitude offset lag, or a latitude offset lag. In a possible implementation, taking the location threshold information including the longitude offset threshold and the latitude offset threshold as an example, the first location information, the second location information and the location threshold information satisfying the first condition includes at least one of: the difference between the longitude in the first longitude and latitude information and the longitude in the second longitude and latitude information being less than or equal to the longitude offset threshold; or the difference between the latitude in the first longitude and latitude information and the latitude in the second longitude and latitude information being less than or equal to the latitude offset threshold.

For example, the terminal device determines that the difference between the longitude in the first longitude and latitude information and the longitude in the second longitude and latitude information is less than or equal to the longitude offset threshold, and/or that the difference between the latitude in the first longitude and latitude information and the latitude in the second longitude and latitude information is less than or equal to the latitude offset threshold, then it may be determined that the first location information, the second location information and the location threshold information satisfy the first condition. In some examples, the terminal device determines that the difference between the longitude in the first longitude and latitude information and the longitude in the second longitude and latitude information is greater than the longitude offset threshold, and/or that the difference between the latitude in the first longitude and latitude information and the latitude in the second longitude and latitude information is greater than the latitude offset threshold, then it may be determined that the first location information, the second location information and the location threshold information do not satisfy the first condition.

In another possible implementation, taking the location threshold information including the longitude offset threshold, the latitude offset threshold, the longitude offset lag and the latitude offset lag as an example, the first location information, the second location information and the location threshold information satisfying the first condition includes at least one of: the difference between the longitude in the first longitude and latitude information and the longitude in the second longitude and latitude information being less than the longitude offset threshold by at least one longitude offset lag; or the difference between the latitude in the first longitude and latitude information and the latitude in the second longitude and latitude information being less than the latitude offset threshold by at least one latitude offset lag.

For example, the terminal device determines that the difference between the longitude in the first longitude and latitude information and the longitude in the second longitude and latitude information is less than the longitude offset threshold by at least one latitude offset lag, and/or that the difference between the latitude in the first longitude and latitude information and the latitude in the second longitude and latitude information is less than the latitude offset threshold by at least one attitude offset lag, then it may be determined that the first location information, the second location information and the location threshold information satisfy the first condition.

In an embodiment of the present disclosure, the first location information is first geographic location information, the second location information is second geographic location information, and the location threshold information includes at least one of a geographic location offset threshold or a geographic location offset lag. In a possible implementation, taking the location threshold information including the geographic location offset threshold as an example, a possible implementation of the first location information, the second location information and the location threshold information satisfying the first condition may be as follows: the gap between the first geographic location information and the second geographic location information being less than or equal to the geographic location offset threshold.

For example, the terminal device determines that the gap between the first geographic location information and the second geographic location information is less than or equal to the geographic location offset threshold, then it may be determined that the first location information, the second location information and the location threshold information satisfy the first condition. In some examples, the terminal device determines that the gap between the first geographic location information and the second geographic location information is greater than the geographic location offset threshold, then it may be determined that the first location information, the second location information and the location threshold information do not satisfy the first condition.

In another possible implementation, taking the location threshold information including the geographic location offset threshold and the geographic location offset lag as an example, a possible implementation of the first location information, the second location information and the location threshold information satisfying the first condition may be as follows: the gap between the first geographic location information and the second geographic location information being less than the geographic location offset threshold by at least one geographic location offset lag.

For example, the terminal device determines that the gap between the first geographic location information and the second geographic location information is less than the geographic location offset threshold by at least one geographic location offset lag, then it may be determined that the first location information, the second location information and the location threshold information satisfy the first condition.

In an embodiment of the present disclosure, the speed threshold information includes at least one of a speed offset threshold or a speed offset lag. In a possible implementation, taking the speed threshold information including the speed offset threshold as an example, an implementation of the first speed information, the second speed information and the speed threshold information satisfying the second condition may be as follows: the difference between the first speed information and the second speed information being less than or equal to the speed offset threshold.

For example, the terminal device determines that the difference between the first speed information and the second speed information is less than or equal to the speed offset threshold, then it may be determined that the first speed information, the second speed information and the speed threshold information satisfy the second condition. In some examples, the terminal device determines that the difference between the first speed information and the second speed information is greater than the speed offset threshold, then it may be determined that the first speed information, the second speed information and the speed threshold information do not satisfy the second condition.

In another possible implementation, taking the speed threshold information including the speed offset threshold and the speed offset lag as an example, an implementation of the first speed information, the second speed information and the speed threshold information satisfying the second condition may be as follows: the difference between the first speed information and the second speed information being less than the speed offset threshold by at least one speed offset lag.

For example, the terminal device determines that the difference between the first speed information and the second speed information is less than the speed offset threshold by at least one speed offset lag, then it may be determined that the first speed information, the second speed information and the speed threshold information satisfy the second condition.

In some examples, in some embodiments of the present disclosure, the configuration information may further include a first evaluation time. In an embodiment of the present disclosure, an implementation of determining, in response to determining that the first location information, the second location information and the location threshold information satisfy the first condition and that the first speed information, the second speed information and the speed threshold information satisfy the second condition, that the terminal device moves together with the IAB-node may be as follows: determining, in response to determining that the duration for which the first location information, the second location information and the location threshold information satisfy the first condition and the duration for which the first speed information, the second speed information and the speed threshold information satisfy the second condition are both greater than or equal to the first evaluation time, that the terminal device moves together with the IAB-node.

For example, the terminal device determines that the duration for which the first location information, the second location information and the location threshold information satisfy the first condition is greater than or equal to the first evaluation time, and that the duration for which the first speed information, the second speed information and the speed threshold information satisfy the second condition is greater than or equal to the first evaluation time, then it may be determined that the terminal device moves together with the IAB-node. The way to determine that the first location information, the second location information and the location threshold information satisfy the first condition, as well as the way to determine that the first speed information, the second speed information and the speed threshold information satisfy the second condition, can be implemented in any means of various embodiments of the present disclosure, respectively, which is not limited by the embodiments of the present disclosure and will not be repeated.

In some embodiments of the present disclosure, the first information includes the first location information and the first direction information, and the configuration information includes the second location information of the IAB-node, the location threshold information, the second direction information of the IAB-node, and the direction threshold information. In an embodiment of the present disclosure, a possible implementation of judging, according to the first information of the terminal device and the second information of the integrated access and backhaul (IAB)-node, whether the terminal device moves together with the IAB-node is as follows: determining, in response to determining that the first location information, the second location information and the location threshold information satisfy the first condition and that the first direction information, the second direction information and the direction threshold information satisfy the third condition, that the terminal device moves together with the IAB-node.

For example, taking configuring the second location information of the IAB-node, the location threshold information, the second direction information of the IAB-node and the direction threshold information as an example, the terminal device determines that the first location information, the second location information and the location threshold information satisfy the first condition and that the first direction information, the second direction information and the direction threshold information satisfy the third condition, then it may be determined that the terminal device moves together with the IAB-node. For another example, the terminal device determines that the first location information, the second location information and the location threshold information do not satisfy the first condition, and/or that the first direction information, the second direction information and the direction threshold information do not satisfy the third condition, then it may be determined that the terminal device does not move together with the IAB-node. In this embodiment, the way to determine that the first location information, the second location information and the location threshold information satisfy the first condition, as well as the way to determine that the first direction information, the second direction information and the direction threshold information satisfy the third condition, can be implemented in any means of various embodiments of the present disclosure, respectively, which is not limited by the embodiments of the present disclosure and will not be repeated.

In an embodiment of the present disclosure, the direction threshold information includes at least one of a direction angle offset threshold or a direction angle offset lag. In a possible implementation, taking the direction threshold information including the direction angle offset threshold as an example, an implementation of the first direction information, the second direction information and the direction threshold information satisfying the third condition may be as follows: the angle difference between the first direction information and the second direction information being less than or equal to the direction angle offset threshold.

For example, the terminal device determines that the angle difference between the first direction information and the second direction information is less than or equal to the direction angle offset threshold, then it may be determined that the first direction information, the second direction information and the direction threshold information satisfy the third condition. In some examples, the terminal device determines that the angle difference between the first direction information and the second direction information is greater than the direction angle offset threshold, then it may be determined that the first direction information, the second direction information and the direction threshold information do not satisfy the third condition.

In another possible implementation, taking the direction threshold information including the direction angle offset threshold and the direction angle offset lag as an example, an implementation of the first direction information, the second direction information and the direction threshold information satisfying the third condition may be as follows: the angle difference between the first direction information and the second direction information being less than the direction angle offset threshold by at least one direction angle offset lag.

For example, the terminal device determines that the angle difference between the first direction information and the second direction information is less than the direction angle offset threshold by at least one direction angle offset lag, then it may be determined that the first direction information, the second direction information and the direction threshold information satisfy the third condition.

In some examples, in some embodiments of the present disclosure, the configuration information may further include a second evaluation time. In an embodiment of the present disclosure, an implementation of determining, in response to determining that the first location information, the second location information and the location threshold information satisfy the first condition and that the first direction information, the second direction information and the direction threshold information satisfy the third condition, that the terminal device moves together with the IAB-node may be as follows: determining, in response to determining that the duration for which the first location information, the second location information and the location threshold information satisfy the first condition and the duration for which the first direction information, the second direction information and the direction threshold information satisfy the third condition are both greater than or equal to the second evaluation time, that the terminal device moves together with the IAB-node.

For example, taking configuring the second location information of the IAB-node, the location threshold information, the second direction information of the IAB-node, the direction threshold information and the second evaluation time as an example, the terminal device determines that the duration for which the first location information, the second location information and the location threshold information satisfy the first condition is greater than or equal to the second evaluation time, and that the duration for which the first direction information, the second direction information and the direction threshold information satisfy the third condition is greater than or equal to the second evaluation time, then it may be determined that the terminal device moves together with the IAB-node. The way to determine that the first location information, the second location information and the location threshold information satisfy the first condition, as well as the way to determine that the first direction information, the second direction information and the direction threshold information satisfy the third condition, can be implemented in any means of various embodiments of the present disclosure, respectively, which is not limited by the embodiments of the present disclosure and will not be repeated.

In some embodiments of the present disclosure, the first information includes the first speed information and the first direction information, and the configuration information includes the second speed information of the IAB-node, the speed threshold information, the second direction information of the IAB-node, and the direction threshold information. In an embodiment of the present disclosure, a possible implementation of judging, according to the first information of the terminal device and the second information of the IAB-node, whether the terminal device moves together with the IAB-node is as follows: determining, in response to determining that the first speed information, the second speed information and the speed threshold information satisfy the second condition and that the first direction information, the second direction information and the direction threshold information satisfy the third condition, that the terminal device moves together with the IAB-node.

For example, taking configuring the second speed information of the IAB-node, the speed threshold information, the second direction information of the IAB-node and the direction threshold information as an example, the terminal device determines that the first speed information, the second speed information and the speed threshold information satisfy the second condition and that the first direction information, the second direction information and the direction threshold information satisfy the third condition, then it may be determined that the terminal device moves together with the IAB-node. For another example, the terminal device determines that the first speed information, the second speed information and the speed threshold information do not satisfy the second condition, and/or the first direction information, the second direction information and the direction threshold information do not satisfy the third condition, then it may be determined that the terminal device does not move together with the IAB-node. In this embodiment, the way to determine that the first speed information, the second speed information and the speed threshold information satisfy the second condition, as well as the way to determine that the first direction information, the second direction information and the direction threshold information satisfy the third condition, can be implemented in any means of various embodiments of the present disclosure, respectively, which is not limited by the embodiments of the present disclosure and will not be repeated.

In some examples, in some embodiments of the present disclosure, the configuration information further includes a third evaluation time. In an embodiment of the present disclosure, taking configuring the second speed information of the IAB-node, the speed threshold information, the second direction information of the IAB-node, the direction threshold information and the third evaluation time as an example, an implementation of determining, in response to determining that the first speed information, the second speed information and the speed threshold information satisfy the second condition and that the first direction information, the second direction information and the direction threshold information satisfy the third condition, that the terminal device moves together with the IAB-node may be as follows: determining, in response to determining that the duration for which the first speed information, the second speed information and the speed threshold information satisfy the second condition and the duration for which the first direction information, the second direction information and the direction threshold information satisfy the third condition are both greater than or equal to the third evaluation time, that the terminal device moves together with the IAB-node.

For example, the terminal device determines that the first speed information, the second speed information and the speed threshold information satisfy the second condition and that the first direction information, the second direction information and the direction threshold information satisfy the third condition, then it may be determined that the terminal device moves together with the IAB-node. For another example, the terminal device determines that the first speed information, the second speed information and the speed threshold information do not satisfy the second condition and/or that the first direction information, the second direction information and the direction threshold information do not satisfy the third condition, then it may be determined that the terminal device does not move together with the IAB-node. In this embodiment, the way to determine that the first speed information, the second speed information and the speed threshold information satisfy the second condition, as well as the way to determine that the first direction information, the second direction information and the direction threshold information satisfy the third condition, can be implemented in any means of various embodiments of the present disclosure, respectively, which is not limited by the embodiments of the present disclosure and will not be repeated.

In some embodiments of the present disclosure, the first information includes the first location information, the first speed information, and the first direction information, and the configuration information includes the second location information of the IAB-node, the location threshold information, the second speed information of the IAB-node, the speed threshold information, the second direction information of the IAB-node, and the direction threshold information. In an embodiment of the present disclosure, a possible implementation of judging, according to the first information of the terminal device and the second information of the IAB-node, whether the terminal device moves together with the IAB-node is as follows: determining, in response to determining that the first location information, the second location information and the location threshold information satisfy the first condition and that the first speed information, the second speed information and the speed threshold information satisfy the second condition, that the terminal device moves together with the IAB-node.

In a possible implementation, taking configuring the second location information of the IAB-node, the location threshold information, the second speed information of the IAB-node, the speed threshold information, the second direction information of the IAB-node and the direction threshold information as an example, the terminal device determines that the first location information, the second location information and the location threshold information satisfy the first condition and that the first speed information, the second speed information and the speed threshold information satisfy the second condition, then it may be determined that the terminal device moves together with the IAB-node.

In a possible implementation, taking configuring the second location information of the IAB-node, the location threshold information, the second speed information of the IAB-node, the speed threshold information, the second direction information of the IAB-node and the direction threshold information as an example, a possible implementation of judging, according to the first information of the terminal device and the second information of the IAB-node, whether the terminal device moves together with the IAB-node is as follows: determining, in response to determining that the first location information, the second location information and the location threshold information satisfy the first condition and that the first direction information, the second direction information and the direction threshold information satisfy the third condition, that the terminal device moves together with the IAB-node. For example, if the second location information of the IAB-node, the location threshold information, the second speed information of the IAB-node, the speed threshold information, the second direction information of the IAB-node and the direction threshold information are configured, the terminal device determines that the first location information, the second location information and the location threshold information satisfy the first condition and that the first direction information, the second direction information and the direction threshold information satisfy the third condition, then it may be determined that the terminal device moves together with the IAB-node.

In a possible implementation, taking configuring the second location information of the IAB-node, the location threshold information, the second speed information of the IAB-node, the speed threshold information, the second direction information of the IAB-node and the direction threshold information as an example, a possible implementation of judging, according to the first information of the terminal device and the second information of the IAB-node, whether the terminal device moves together with the IAB-node is as follows: determining, in response to determining that the first speed information, the second speed information and the speed threshold information satisfy the second condition and that the first direction information, the second direction information and the direction threshold information satisfy the third condition, that the terminal device moves together with the IAB-node. For example, if the second location information of the IAB-node, the location threshold information, the second speed information of the IAB-node, the speed threshold information, the second direction information of the IAB-node and the direction threshold information are configured, the terminal device determines that the first speed information, the second speed information and the speed threshold information satisfy the second condition and that the first direction information, the second direction information and the direction threshold information satisfy the third condition, then it may be determined that the terminal device moves together with the IAB-node.

In a possible implementation, taking configuring the second location information of the IAB-node, location threshold information, the second speed information of the IAB-node, the speed threshold information, the second direction information of the IAB-node and the direction threshold information as an example, a possible implementation of judging, according to the first information of the terminal device and the second information of the IAB-node, whether the terminal device moves together with the IAB-node is as follows: determining, in response to determining that the first location information, the second location information and the location threshold information satisfy the first condition, that the first speed information, the second speed information and the speed threshold information satisfy the second condition, and that the first direction information, the second direction information and the direction threshold information satisfy the third condition, that the terminal device moves together with the IAB-node. For example, if the second location information of the IAB-node, the location threshold information, the second speed information of the IAB-node, the speed threshold information, the second direction information of the IAB-node and the direction threshold information are configured, the terminal device determines that the first location information, the second location information and the location threshold information satisfy the first condition, that the first speed information, the second speed information and the speed threshold information satisfy the second condition, and that the first direction information, the second direction information and the direction threshold information satisfy the third condition, then it may be determined that the terminal device moves together with the IAB-node.

In some examples, in some embodiments of the present disclosure, the first information includes the first location information, the first speed information, and the first direction information, and the configuration information includes the second location information of the IAB-node, the location threshold information, the second speed information of the IAB-node, the speed threshold information, the second direction information of the IAB-node, the direction threshold information, and the first evaluation time. In an embodiment of the present disclosure, a possible implementation of judging, according to the configuration information and the first information, whether the terminal device moves together with the IAB-node is as follows: determining, in response to determining that the duration for which the first location information, the second location information and the location threshold information satisfy the first condition and the duration for which the first speed information, the second speed information and the speed threshold information satisfy the second condition are both greater than or equal to the first evaluation time, that the terminal device moves together with the IAB-node.

In a possible implementation, taking configuring the second location information of the IAB-node, the location threshold information, the second speed information of the IAB-node, the speed threshold information, the second direction information of the IAB-node, the direction threshold information and the second evaluation time as an example, a possible implementation of judging, according to the first information of the terminal device and the second information of the IAB-node, whether the terminal device moves together with the IAB-node is as follows: determining, in response to determining that the duration for which the first location information, the second location information and the location threshold information satisfy the first condition and the duration for which the first direction information, the second direction information and the direction threshold information satisfy the third condition are both greater than or equal to the second evaluation time, that the terminal device moves together with the IAB-node.

In a possible implementation, taking configuring the second location information of the IAB-node, the location threshold information, the second speed information of the IAB-node, the speed threshold information, the second direction information of the IAB-node, the direction threshold information and the third evaluation time as an example, a possible implementation of judging, according to the first information of the terminal device and the second information of the IAB-node, whether the terminal device moves together with the IAB-node is as follows: determining, in response to determining that the duration for which the first speed information, the second speed information and the speed threshold information satisfy the second condition and the duration for which the first direction information, the second direction information and the direction threshold information satisfy the third condition are both greater than or equal to the third evaluation time, that the terminal device moves together with the IAB-node.

In a possible implementation, taking configuring the second location information of the IAB-node, the location threshold information, the second speed information of the IAB-node, the speed threshold information, the second direction information of the IAB-node, the direction threshold information and the fourth evaluation time as an example, a possible implementation of judging, according to the first information of the terminal device and the second information of the IAB-node, whether the terminal device moves together with the IAB-node is as follows: determining, in response to determining that the duration for which the first location information, the second location information and the location threshold information satisfy the first condition, the duration for which the first speed information, the second speed information and the speed threshold information satisfy the second condition, and the duration for which the first direction information, the second direction information and the direction threshold information satisfy the third condition are all greater than or equal to the fourth evaluation time, that the terminal device moves together with the IAB-node.

It is to be noted that the above embodiments are not exhaustive, but schematic for part of the embodiments, and the above embodiments can be implemented separately, or in combination of a plurality of embodiments. The above embodiments are schematic, rather than specific limitations on the scope of protection of the embodiments of the present disclosure.

It can be understood that the above embodiments are implementations of the method for determining movement of the embodiments of the present disclosure as described from a terminal device side. An embodiment of the present disclosure further provides a method for determining movement, and the implementation of the method for determining movement will be described below from an IAB-donor side. It is to be noted that with respect to the implementation of how the configuration information assists the terminal device in determining whether the terminal device is an on-board device, reference is made to the aforementioned implementation from the terminal device side, which will not be repeated here. Reference is made to FIG. 4, which is a flowchart of a method for determining movement provided by another embodiment of the present disclosure. It is to be noted that an IAB donor can determine movement in the embodiment of the present disclosure. As shown in FIG. 4, the method may include but is not limited to the following steps.

In step 401, configuration information is transmitted to a terminal device, where the configuration information is used to assist the terminal device in judging whether the terminal device moves together with an IAB-node.

In an implementation, a possible implementation of transmitting configuration information to the terminal device may be as follows: transmitting the configuration information to the terminal device via a system message, or transmitting the configuration information to the terminal device via dedicated radio resource control (RRC) signaling.

For example, the IAB-donor may configure the configuration information to the terminal device via system message or dedicated RRC signaling. If the terminal device is in an IDLE/INACTIVE state, the terminal device obtains the configuration information via the system message transmitted by the IAB-donor. If the terminal device is in a CONNECTED state, the terminal device may acquire the configuration information via the system message/dedicated RRC signaling transmitted by the IAB-donor.

In some embodiments of the present disclosure, the configuration information includes at least one of: second location information of the IAB-node; location threshold information; second speed information of the IAB-node; speed threshold information; second direction information of the IAB-node; direction threshold information; or an evaluation time.

In an implementation, the second location information is second longitude and latitude information, and the location threshold information includes at least one of a longitude offset threshold, a latitude offset threshold, a longitude offset lag, or a latitude offset lag; alternatively, the second location information is second geographic location information, and the location threshold information includes at least one of a geographic location offset threshold or a geographic location offset lag.

In a possible implementation, the longitude offset threshold is the same as the latitude offset threshold, or the longitude offset threshold is different from the latitude offset threshold; the longitude offset lag is the same as the latitude offset lag, or the longitude offset lag is different from the latitude offset lag.

In a possible implementation, the speed threshold information includes at least one of: a speed offset threshold; or a speed offset lag.

In a possible implementation, the direction threshold information includes at least one of: a direction angle offset threshold; or a direction angle offset lag.

By implementing the embodiments of the present disclosure, by transmitting configuration information to a terminal device to assist the terminal device in determining whether it is an on-board terminal, the problem of how to judge, during the movement of the IAB-node, whether the terminal device moves together with the IAB-node can be solved, so that the terminal device that moves together with the IAB-node can preferentially access the IAB-node, guaranteeing the normal communication of the terminal device.

In the above embodiments provided by the present disclosure, the methods provided by the embodiments of the present disclosure are introduced from the perspectives of the terminal device and the IAB-donor, respectively. In order to implement various functions in the methods provided by the embodiments of the present disclosure, the terminal device and the IAB-donor may include a hardware structure and a software module, and implement the above functions in the form of the hardware structure, the software module, or the hardware structure plus the software module. A certain function in the above functions can be executed in the form of the hardware structure, the software module, or the hardware structure plus the software module.

Reference is made to FIG. 5, which is a schematic structural diagram of a communication device 50 provided by an embodiment of the present disclosure. The communication device 50 as shown in FIG. 5 may include a transceiver module 501 and a processing module 502. The transceiver module 501 may include a transmitting module and/or a receiving module. The transmitting module is configured to implement a transmitting function, the receiving module is configured to implement a receiving function, and the transceiver module 501 may implement a transmitting function and/or a receiving function.

The communication device 50 may be a terminal device, or may be a device in the terminal device, or may be a device that can match the terminal device for use. Or, the communication device 50 may be an IAB-donor, or may be a device in the IAB-donor, or may be a device that can match the IAB-donor for use.

The communication device 50 is a terminal device: the processing module 502 is configured to obtain first information of the terminal device; the processing module 502 is further configured to judge, according to the first information of the terminal device and second information of an IAB-node, whether the terminal device moves together with the IAB-node.

In an implementation, the transceiver module 501 is configured to receive configuration information transmitted by the IAB-donor; the processing module 502 is further configured to determine, according to the configuration information, the second information of the IAB-node.

In an optional implementation, the first information of the terminal device includes at least two of first location information of the terminal device, first speed information of the terminal device, or first direction information of the terminal device. The second information of the IAB-node includes at least two of second location information of the IAB-node, second speed information of the IAB-node, or second direction information of the IAB-node.

In a possible implementation, the first information includes the first location information and the first speed information, and the configuration information includes the second location information of the IAB-node, location threshold information, the second speed information of the IAB-node, and speed threshold information. The processing module 502 is specifically configured to: determine, in response to determining that the first location information, the second location information and the location threshold information satisfy a first condition and that the first speed information, the second speed information and the speed threshold information satisfy a second condition, that the terminal device moves together with the IAB-node.

In a possible implementation, the configuration information will include the first evaluation time. The processing module 502 is specifically configured to: determine, in response to determining that the duration for which the first location information, the second location information and the location threshold information satisfy the first condition and the duration for which the first speed information, the second speed information and the speed threshold information satisfy the second condition are both greater than or equal to the first evaluation time, that the terminal device moves together with the IAB-node.

In a possible implementation, the first information includes the first location information and the first direction information, and the configuration information includes the second location information of the IAB-node, the location threshold information, the second direction information of the IAB-node, and direction threshold information. The processing module 502 is specifically configured to: determine, in response to determining that the first location information, the second location information and the location threshold information satisfy the first condition and that the first direction information, the second direction information and the direction threshold information satisfy a third condition, that the terminal device moves together with the IAB-node.

In a possible implementation, the configuration information further includes a second evaluation time. The processing module 502 is specifically configured to: determine, in response to determining that the duration for which the first location information, the second location information and the location threshold information satisfy the first condition and the duration for which the first direction information, the second direction information and the direction threshold information satisfy the third condition are both greater than or equal to the second evaluation time, that the terminal device moves together with the IAB-node.

In a possible implementation, the first information includes the first speed information and the first direction information, and the configuration information includes the second speed information of the IAB-node, the speed threshold information, the second direction information of the IAB-node, and the direction threshold information. The processing module 502 is specifically configured to: determine, in response to determining that the first speed information, the second speed information and the speed threshold information satisfy the second condition and that the first direction information, the second direction information and the direction threshold information satisfy the third condition, that the terminal device moves together with the IAB-node.

In a possible implementation, the configuration information further includes a third evaluation time. The processing module 502 is specifically configured to: determine, in response to determining that the duration for which the first speed information, the second speed information and the speed threshold information satisfy the second condition and the duration for which the first direction information, the second direction information and the direction threshold information satisfy the third condition are both greater than or equal to the third evaluation time, that the terminal device moves together with the IAB-node.

In a possible implementation, the first information includes the first location information, the first speed information, and the first direction information, and the configuration information includes the second location information of the IAB-node, the location threshold information, the second speed information of the IAB-node, the speed threshold information, the second direction information of the IAB-node, and the direction threshold information. The processing module 502 is specifically configured to: determine, in response to determining that the first location information, the second location information and the location threshold information satisfy the first condition and that the first speed information, the second speed information and the speed threshold information satisfy the second condition, that the terminal device moves together with the IAB-node; or, determine, in response to determining that the first location information, the second location information and the location threshold information satisfy the first condition and that the first direction information, the second direction information and the direction threshold information satisfy the third condition, that the terminal device moves together with the IAB-node; or, determine, in response to determining that the first speed information, the second speed information and the speed threshold information satisfy the second condition and that the first direction information, the second direction information and the direction threshold information satisfy the third condition, that the terminal device moves together with the IAB-node; or, determine, in response to determining that the first location information, the second location information and the location threshold information satisfy the first condition, that the first speed information, the second speed information and the speed threshold information satisfy the second condition, and that the first direction information, the second direction information and the direction threshold information satisfy the third condition, that the terminal device moves together with the IAB-node.

In a possible implementation, the first information includes the first location information, the first speed information and the first direction information, and the configuration information includes the second location information of the IAB-node, the location threshold information, the second speed information of the IAB-node, the speed threshold information, the second direction information of the IAB-node, the direction threshold information, and the evaluation time, the evaluation time includes a first evaluation time, a second evaluation time, a third evaluation time and a fourth evaluation time. The processing module 502 is specifically configured to: determine, in response to determining that the duration for which the first location information, the second location information and the location threshold information satisfy the first condition and the duration for which the first speed information, the second speed information and the speed threshold information satisfy the second condition are both greater than or equal to the first evaluation time, that the terminal device moves together with the IAB-node; or, determine, in response to determining that the duration for which the first location information, the second location information and the location threshold information satisfy the first condition and the duration for which the first direction information, the second direction information and the direction threshold information satisfy the third condition are both greater than or equal to the second evaluation time, that the terminal device moves together with the IAB-node; or, determine, in response to determining that the duration for which the first speed information, the second speed information and the speed threshold information satisfy the second condition and the duration for which the first direction information, the second direction information and the direction threshold information satisfy the third condition are both greater than or equal to the third evaluation time, that the terminal device moves together with the IAB-node; or, determine, in response to determining that the duration for which the first location information, the second location information and the location threshold information satisfy the first condition, the duration for which the first speed information, the second speed information and the speed threshold information satisfy the second condition and the duration for which the first direction information, the second direction information and the direction threshold information satisfy the third condition are all greater than or equal to the fourth evaluation time, that the terminal device moves together with the IAB-node.

In a possible implementation, the first location information is first longitude and latitude information, the second location information is second longitude and latitude information, and the location threshold information includes at least one of a longitude offset threshold, a latitude offset threshold, a longitude offset lag, or a latitude offset lag. The first location information, the second location information and the location threshold information satisfying the first condition includes at least one of: the difference between the longitude in the first longitude and latitude information and the longitude in the second longitude and latitude information being less than or equal to the longitude offset threshold; or the difference between the latitude in the first longitude and latitude information and the latitude in the second longitude and latitude information being less than or equal to the latitude offset threshold. Alternatively, the first location information, the second location information and the location threshold information satisfying the first condition includes at least one of: the difference between the longitude in the first longitude and latitude information and the longitude in the second longitude and latitude information being less than the longitude offset threshold by at least one longitude offset lag; or the difference between the latitude in the first longitude and latitude information and the latitude in the second longitude and latitude information being less than the latitude offset threshold by at least one latitude offset lag.

In a possible implementation, the longitude offset threshold is the same as the latitude offset threshold, or the longitude offset threshold is different from the latitude offset threshold; the longitude offset lag is the same as the latitude offset lag, or the longitude offset lag is different from the latitude offset lag.

In a possible implementation, the first location information is first geographic location information, the second location information is second geographic location information, and the location threshold information includes at least one of a geographic location offset threshold or a geographic location offset lag. The first location information, the second location information and the location threshold information satisfying the first condition includes: the gap between the first geographic location information and the second geographic location information being less than or equal to the geographic location offset threshold; or, the gap between the first geographic location information and the second geographic location information being less than the geographic location offset threshold by at least one geographic location offset lag. In a possible implementation, the speed threshold information includes at least one of a speed offset threshold or a speed offset lag. The first speed information, the second speed information and the speed threshold information satisfying the second condition includes: the difference between the first speed information and the second speed information being less than or equal to the speed offset threshold; or, the difference between the first speed information and the second speed information being less than the speed offset threshold by at least one speed offset lag.

In a possible implementation, the direction threshold information includes at least one of a direction angle offset threshold or a direction angle offset lag. The first direction information, the second direction information and the direction threshold information satisfying the third condition includes: the angle difference between the first direction information and the second direction information being less than or equal to the direction angle offset threshold; or, the angle difference between the first direction information and the second direction information being less than the direction angle offset threshold by at least one direction angle offset lag.

The communication device 50 is an IAB-donor: the transceiver module 501 is configured to transmit configuration information to a terminal device, where the configuration information is configured to assist the terminal device in judging whether the terminal device moves together with an IAB-node.

In an implementation, transmitting the configuration information to the terminal device includes: transmitting the configuration information to the terminal device via a system message; or, transmitting the configuration information to the terminal device via dedicated radio resource control (RRC) signaling.

In an implementation, the configuration information includes at least one of: second location information of the IAB-node; location threshold information; second speed information of the IAB-node; speed threshold information; second direction information of the IAB-node; direction threshold information; or an evaluation time.

In a possible implementation, the second location information is second longitude and latitude information, and the location threshold information includes at least one of a longitude offset threshold, a latitude offset threshold, a longitude offset lag, or a latitude offset lag; alternatively, the second location information is second geographic location information, and the location threshold information includes at least one of a geographic location offset threshold or a geographic location offset lag.

In a possible implementation, the longitude offset threshold is the same as the latitude offset threshold, or the longitude offset threshold is different from the latitude offset threshold; the longitude offset lag is the same as the latitude offset lag, or the longitude offset lag is different from the latitude offset lag.

In a possible implementation, the speed threshold information includes at least one of: a speed offset threshold; or a speed offset lag.

In a possible implementation, the direction threshold information includes at least one of: a direction angle offset threshold; or a direction angle offset lag.

With regard to the device in the above embodiments, the specific means in which each of the modules performs operations have been described in detail in the embodiments regarding the method, and will not be set forth in detail here.

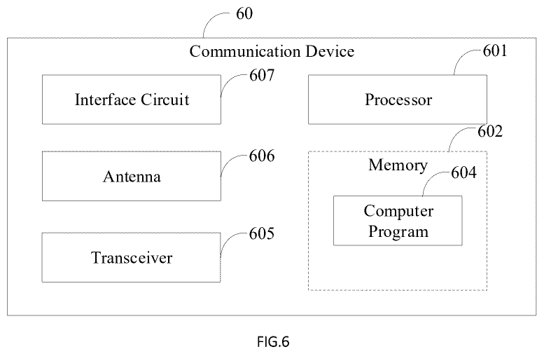

Reference is made to FIG. 6, which is a schematic structural diagram of a communication device 60 provided by another embodiment of the present disclosure. The communication device 60 can be a terminal device, or an IAB-donor, or a chip, chip system, or processor, etc. that supports the terminal device to implement the above methods, or a chip, chip system, or processor, etc. that supports the IAB-donor to implement the above methods. The device may be configured to implement the methods described in the above method embodiments, which can refer to the illustration in the above method embodiments for details.

The communication device 60 may include one or more processors 601. The processor 601 can be a general-purpose processor or a special-purpose processor, etc., such as a baseband processor or a central processing unit. The baseband processor may be configured to process a communication protocol and communication data, and the central processing unit may be configured to control a communication device (such as a base station, a baseband chip, a terminal device, a terminal device chip, a DU, or a CU), execute a computer program, and process data of the computer program.

In some examples, the communication device 60 may further include one or more memories 602, on which a computer program 604 may be stored. The processor 601 executes the computer program 604 to cause the communication device 60 to perform the method described in the above method embodiments. In some examples, the memory 602 may also store data. The communication device 60 and the memory 602 may be set separately, or may be integrated together.

In some examples, the communication device 60 may further include a transceiver 605 and an antenna 606. The transceiver 605 can be referred to as a transceiver unit, a transceiver device, or a transceiver circuit, etc., and is configured to implement a transceiver function. The transceiver 605 may include a receiver and a transmitter. The receiver can be referred to as a receiving device or a receiving circuit, etc., and is configured to implement a receiving function; the transmitter can be referred to as a transmitting device or a transmitting circuit, etc., and is configured to implement a transmitting function.

In some examples, the communication device 60 may further include one or more interface circuits 607. The interface circuit 607 is configured to receive code instructions and transfer same to the processor 601. The processor 601 executes the code instructions to cause the communication device 60 to perform the methods according to the above method embodiments.

The communication device 60 is a terminal device: the processor 601 is configured to execute steps 201 and 202 in FIG. 2; or steps 301, 303 and 304 in FIG. 3. The transceiver 605 is configured to execute step 302 in FIG. 3.

The communication device 60 is an IAB-donor: the transceiver 605 is configured to execute step 401 in FIG. 4.

In an implementation, the processor 601 may include a transceiver configured to implement a receiving function and a transmitting function. For example, the transceiver can be a transceiver circuit, or an interface, or an interface circuit. The transceiver circuit, interface or interface circuit configured to implement a receiving function and a transmitting function may be separated, or may be integrated together. The above transceiver circuit, interface or interface circuit may be configured to read and write codes/data, or the above transceiver circuit, interface or interface circuit may be configured to transfer/deliver signals.

In an implementation, the processor 601 may store a computer program. The computer program, when running on the processor 601, can cause the communication device 60 to perform the methods described in the above method embodiments. The computer program may be solidified in the processor 601, in which case the processor 601 may be implemented in hardware.

In an implementation, the communication device 60 may include a circuit, which may implement a function of transmitting or receiving or communicating in the aforementioned method embodiments. The processor and transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver can also be manufactured with various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), and gallium arsenide (GaAs).

The communication device described in the above embodiments can be PCF, AF, or a terminal device, but the scope of the communication device described in the present disclosure is not limited to this, and the structure of the communication device may not be limited by FIG. 6. The communication device may be a stand-alone device, or may be part of a larger device. For example, the communication device may be:
(1) a stand-alone integrated circuit (IC), or a chip, or a system or subsystem on chip;
(2) a set with one or more ICs, in some examples, the IC set may further include a storage component for storing data and a computer program;
(3) an ASIC, such as a modem;
(4) a module that can be embedded in other devices;
(5) a receiving device, a terminal device, a smart terminal device, a cellular phone, a wireless device, a handset, a mobile unit, an on-board device, a network device, a cloud device, an artificial intelligence device, etc. ; and
(6) others and so.

It can also be understood by those skilled in the art that various illustrative logical blocks and steps as listed in the embodiments of the present disclosure can be implemented in electronic hardware, computer software, or a combination of both. Whether such functions are implemented in hardware or software depends on the specific application and the design requirements of the whole system. It is possible for those skilled in the art to use various methods to implement the stated functions for each specific application, but such implementation should not be understood as beyond the scope of protection of the embodiments of the present disclosure.

An embodiment of the present disclosure further provides a system for determining movement. The system includes a communication device as a terminal device and a communication device as an IAB-donor in the aforementioned embodiments of FIG. 5, or the system includes a communication device as a terminal device and a communication device as an IAB-donor in the aforementioned embodiments of FIG. 6.

The present disclosure further provides a non-transitory computer-readable storage medium having stored thereon instructions, which, when executed by a computer, implement the function of any of the above method embodiments.

The present disclosure further provides a computer program product which, when executed by a computer, implements the function of any of the above method embodiments.

The above embodiments can be implemented in whole or in part by software, hardware, firmware or any combination of these. When implemented in software, the above embodiments can be implemented in whole or in part in the form of a computer program product. The computer program product includes one or more computer programs. When the computer programs are loaded and executed on a computer, the flows or functions according to the embodiments of the present disclosure are generated in whole or in part. The computer can be a general-purpose computer, a special-purpose computer, a computer network, or other programmable device. The computer program can be stored in a computer-readable storage medium, or transferred from one computer-readable storage medium to another. For example, the computer program can be transferred from a website, computer, server or data center to another website, computer or data center in a wired (e.g., coaxial cable, optical fiber, digital subscriber line (DSL)) or wireless (e.g., infrared, radio, microwave, etc.) means. The computer-readable storage medium can be any available medium that is accessible to a computer or a data storage device that contains a server, a data center, etc. that is integrated by one or more available media. The available medium can be a magnetic medium (e.g., floppy disk, hard disk, magnetic tape), an optical medium (e.g., high-density digital video disc (DVD)), or a semiconductor medium (e.g., solid state disk (SSD)), etc.

It can be understood by those of ordinary skill in the art that the numerical symbols such as first and second as involved in the present disclosure are used to distinguish for the convenience of description, and are not used to limit the scope of the embodiments of the present disclosure, but also indicate the order of sequence.

At least one in the present disclosure can also be described as one or more, and a plurality can be two, three, four or more, which is not limited by the present disclosure. In the embodiments of the present disclosure, for a type of technical features, the technical features in this type of technical features are distinguished by “first,” “second,” “third,” “A,” “B,” “C,” “D,” etc. There is no order of sequence or order of size among the technical features as described by the “first,” “second,” “third,” “A,” “B,” “C” and “D”.

The correspondence as shown in each table of the present disclosure can be configured, or can be predefined. The values of the information in each table are examples, and can be configured as other values, which is not limited by the present disclosure. When configuring the correspondence between the information and various parameters, it is not necessary to require all the correspondence shown in each table to be configured. For example, in the tables of the present disclosure, the correspondences as shown by certain rows may not be configured. For another example, appropriate variations and adjustments can be made based on the above tables, such as splitting and merging. The names of the parameters shown by the headings in the above tables can be other names that can be understood by the communication device, and the values or representations of the parameters can be other values or representations that can be understood by the communication device. When implementing the above tables, other data structures can be employed, such as array, queue, container, stack, linear table, pointer, linked list, tree, graph, structural body, class, heap, or hash table.

The pre-definition in the present disclosure can be understood as definition, definition in advance, storage, pre-storage, pre-negotiation, pre-configuration, solidification, or pre-burning.

It can be recognized by those of ordinary skill in the art that the units and algorithm steps of various examples described in conjunction with the embodiments disclosed herein can be implemented in electronic hardware, or a combination of computer software and electronic hardware. Whether such functions are implemented in hardware or software depends on the specific application of the technical solution and the design constraints. It is possible for the professionals to use different methods to implement the described functions for each specific application, but such implementation should not be considered as beyond the scope of the present disclosure.

It can be clearly understood by those skilled in the art that for the convenience and conciseness of description, the specific working processes of the systems, devices and units as described above can refer to the corresponding processes in the aforementioned method embodiments, which will not be repeated here.

It is also to be noted that the description of any process or method in the flowchart or otherwise described herein can be understood as representing a module, segment or part of code that includes one or more executable instructions for implementing customized logic functions or steps of the processes, and the scope of the preferred implementations of the present disclosure include additional implementations. The functions can be performed out of the order as shown or discussed, including being performed in a substantially simultaneous means or in a reverse order according to the functions involved, which should be understood by those skilled in the art to which the embodiments of the present disclosure belong.

The above is the specific implementations of the present disclosure, but the scope of protection of the present disclosure is not limited to this. The changes or substitutions that can be readily conceivable of by any skilled who is familiar with this technical field within the technical scope as disclosed by the present disclosure should fall within the scope of protection of the present disclosure. Consequently, the scope of protection of the present disclosure should be based on the scope of protection of the claims.

1. A method for determining movement, performed by a terminal device, and the method comprising:
obtaining first information of the terminal device; and
judging, according to the first information of the terminal device and second information of an integrated access and backhaul (IAB)-node, whether the terminal device moves together with the IAB-node.

2. The method according to claim 1, further comprising:
receiving configuration information transmitted by an IAB-donor; and
determining, according to the configuration information, the second information of the IAB-node.

3. The method according to claim 2, wherein the first information of the terminal device comprises at least two of first location information of the terminal device, first speed information of the terminal device, or first direction information of the terminal device;
the second information of the IAB-node comprises at least two of: second location information of the IAB-node, second speed information of the IAB-node, or second direction information of the IAB-node.

4. The method according to claim 3, wherein
judging, according to the first information of the terminal device and the second information of the integrated access and backhaul (IAB)-node, whether the terminal device moves together with the IAB-node comprises at least one of:
determining that the terminal device moves together with the IAB-node, in response to determining that the first location information, the second location information and the location threshold information satisfy a first condition and that the first speed information, the second speed information and speed threshold information satisfy a second condition, in a case that the first information comprising the first location information and the first speed information, and the configuration information comprising the second location information of the IAB-node, location threshold information, the second speed information of the IAB-node, and speed threshold information;
determining that the terminal device moves together with the IAB-node, in response to determining that the first location information, the second location information and the location threshold information satisfy the first condition and that the first direction information, the second direction information and direction threshold information satisfy a third condition, in a case that the first information comprising the first location information and the first direction information, and the configuration information comprising the second location information of the IAB-node, location threshold information, the second direction information of the IAB-node, and the direction threshold information; or
determining that the terminal device moves together with the IAB-node, in response to determining that the first speed information, the second speed information and the speed threshold information satisfy the second condition and that the first direction information, the second direction information and the direction threshold information satisfy the third condition, in a case that the first information comprising the first speed information and the first direction information, and the configuration information comprising the second speed information of the IAB-node, speed threshold information, the second direction information of the IAB-node, and the direction threshold information.

5. The method according to claim 4, wherein the configuration information further comprises a first evaluation time; wherein
determining that the terminal device moves together with the IAB-node, in response to determining that the first location information, the second location information and the location threshold information satisfy the first condition and that the first speed information, the second speed information and the speed threshold information satisfy the second condition comprises:
determining that the terminal device moves together with the IAB-node, in response to determining that the duration for which the first location information, the second location information and the location threshold information satisfy the first condition and the duration for which the first speed information, the second speed information and the speed threshold information satisfy the second condition are both greater than or equal to the first evaluation time.

6. (canceled)

7. The method according to claim 4, wherein the configuration information further comprises a second evaluation time; wherein
determining that the terminal device moves together with the IAB-node, in response to determining that the first location information, the second location information and the location threshold information satisfy the first condition and that the first direction information, the second direction information and the direction threshold information satisfy the third condition comprises:
determining that the terminal device moves together with the IAB-node, in response to determining that the duration for which the first location information, the second location information and the location threshold information satisfy the first condition and the duration for which the first direction information, the second direction information and the direction threshold information satisfy the third condition are both greater than or equal to the second evaluation time.

8. (canceled)

9. The method according to claim 4, wherein the configuration information further comprises a third evaluation time; wherein
determining that the terminal device moves together with the IAB-node, in response to determining that the first speed information, the second speed information and the speed threshold information satisfy the second condition and that the first direction information, the second direction information and the direction threshold information satisfy the third condition comprises:
determining that the terminal device moves together with the IAB-node, in response to determining that the duration for which the first speed information, the second speed information and the speed threshold information satisfy the second condition and the duration for which the first direction information, the second direction information and the direction threshold information satisfy the third condition are both greater than or equal to the third evaluation time.

10. The method according to claim 3, wherein the first information comprises the first location information, the first speed information and the first direction information, and the configuration information comprises the second location information of the IAB-node, location threshold information, the second speed information of the IAB-node, speed threshold information, the second direction information of the IAB-node, and direction threshold information; wherein judging, according to the first information of the terminal device and the second information of the IAB-node, whether the terminal device moves together with the IAB-node comprises at least one of:
determining that the terminal device moves together with the IAB-node, in response to determining that the first location information, the second location information and the location threshold information satisfy a first condition and that the first speed information, the second speed information and the speed threshold information satisfy a second condition;
determining that the terminal device moves together with the IAB-node, in response to determining that the first location information, the second location information and the location threshold information satisfy the first condition and that the first direction information, the second direction information and the direction threshold information satisfy a third condition;
determining that the terminal device moves together with the IAB-node, in response to determining that the first speed information, the second speed information and the speed threshold information satisfy the second condition and that the first direction information, the second direction information and the direction threshold information satisfy the third condition;
or,
determining that the terminal device moves together with the IAB-node, in response to determining that the first location information, the second location information and the location threshold information satisfy the first condition, that the first speed information, the second speed information and the speed threshold information satisfy the second condition, and that the first direction information, the second direction information and the direction threshold information satisfy the third condition.

11. The method according to claim 3, wherein the first information comprises the first location information, the first speed information and the first direction information, and the configuration information comprises the second location information of the IAB-node, location threshold information, the second speed information of the IAB-node, speed threshold information, the second direction information of the IAB-node, direction threshold information, and an evaluation time, the evaluation time comprises a first evaluation time, a second evaluation time, a third evaluation time and a fourth evaluation time; wherein judging, according to the first information of the terminal device and the second information of the IAB-node, whether the terminal device moves together with the IAB-node comprises at least one of:
determining that the terminal device moves together with the IAB-node, in response to determining that the duration for which the first location information, the second location information and the location threshold information satisfy a first condition and the duration for which the first speed information, the second speed information and the speed threshold information satisfy a second condition are both greater than or equal to the first evaluation time;
determining that the terminal device moves together with the IAB-node, in response to determining that the duration for which the first location information, the second location information and the location threshold information satisfy the first condition and the duration for which the first direction information, the second direction information and the direction threshold information satisfy a third condition are both greater than or equal to the second evaluation time;
determining that the terminal device moves together with the IAB-node, in response to determining that the duration for which the first speed information, the second speed information and the speed threshold information satisfy the second condition and the duration for which the first direction information, the second direction information and the direction threshold information satisfy the third condition are both greater than or equal to the third evaluation time;
or,
determining that the terminal device moves together with the IAB-node, in response to determining that the duration for which the first location information, the second location information and the location threshold information satisfy the first condition, the duration for which the first speed information, the second speed information and the speed threshold information satisfy the second condition, and the duration for which the first direction information, the second direction information and the direction threshold information satisfy the third condition are all greater than or equal to the fourth evaluation time.

12. The method according to claim 4, wherein the first location information is first longitude and latitude information, the second location information is second longitude and latitude information, and the location threshold information comprises at least one of a longitude offset threshold, a latitude offset threshold, a longitude offset lag, or a latitude offset lag; wherein
the first location information, the second location information and the location threshold information satisfying the first condition comprises at least one of:
the difference between the longitude in the first longitude and latitude information and the longitude in the second longitude and latitude information being less than or equal to the longitude offset threshold;
the difference between the latitude in the first longitude and latitude information and the latitude in the second longitude and latitude information being less than or equal to the latitude offset threshold;
the difference between the longitude in the first longitude and latitude information and the longitude in the second longitude and latitude information being less than the longitude offset threshold by at least one longitude offset lag; or
the difference between the latitude in the first longitude and latitude information and the latitude in the second longitude and latitude information being less than the latitude offset threshold by at least one latitude offset lag.

13. The method according to claim 12, wherein
the longitude offset threshold is the same as the latitude offset threshold, or the longitude offset threshold is different from the latitude offset threshold;
the longitude offset lag is the same as the latitude offset lag, or the longitude offset lag is different from the latitude offset lag.

14. The method according to claim 4, wherein the first location information is first geographic location information, the second location information is second geographic location information, and the location threshold information comprises at least one of a geographic location offset threshold or a geographic location offset lag; wherein
the first location information, the second location information and the location threshold information satisfying the first condition comprises:
the gap between the first geographic location information and the second geographic location information being less than or equal to the geographic location offset threshold; or
the gap between the first geographic location information and the second geographic location information being less than the geographic location offset threshold by at least one geographic location offset lag.

15. The method according to claim 4, wherein the speed threshold information comprises at least one of a speed offset threshold or a speed offset lag; wherein
the first speed information, the second speed information and the speed threshold information satisfying the second condition comprises at least one of:
the difference between the first speed information and the second speed information being less than or equal to the speed offset threshold;
or,
the difference between the first speed information and the second speed information being less than the speed offset threshold by at least one speed offset lag.

16. The method according to claim 4, wherein the direction threshold information comprises at least one of a direction angle offset threshold or a direction angle offset lag; wherein
the first direction information, the second direction information and the direction threshold information satisfying the third condition comprises at least one of:
the angle difference between the first direction information and the second direction information being less than or equal to the direction angle offset threshold;
or,
the angle difference between the first direction information and the second direction information being less than the direction angle offset threshold by at least one direction angle offset lag.

17. A method for determining movement, performed by an integrated access and backhaul (IAB)-donor, and the method comprising:
transmitting configuration information to a terminal device, wherein the configuration information is used to assist the terminal device in judging whether the terminal device moves together with an IAB-node.

18. The method according to claim 17, wherein transmitting the configuration information to the terminal device comprises:
transmitting the configuration information to the terminal device via a system message;
or,
transmitting the configuration information to the terminal device via dedicated radio resource control (RRC) signaling.

19. The method according to claim 17, wherein the configuration information comprises at least one of:
second location information of the IAB-node;
location threshold information;
second speed information of the IAB-node;
speed threshold information;
second direction information of the IAB-node;
direction threshold information; or
an evaluation time.

20. The method according to claim 19, wherein
the second location information is second longitude and latitude information, and the location threshold information comprises at least one of a longitude offset threshold, a latitude offset threshold, a longitude offset lag, or a latitude offset lag;
or,
the second location information is second geographic location information, and the location threshold information comprises at least one of a geographic location offset threshold or a geographic location offset lag;
or,
the speed threshold information comprises at least one of a speed offset threshold or a speed offset lag;
or,
the direction threshold information comprises at least one of a direction angle offset threshold or a direction angle offset lag.

21-25. (canceled)

26. A communication device, comprising:
one or more processors and a memory, wherein the memory has stored a computer program thereon, and the one or more processors are collectively configured to execute the computer program stored on the memory to cause the communication device to:
obtain first information of the terminal device; and
judge, according to the first information of the terminal device and second information of an integrated access and backhaul (IAB)-node, whether the terminal device moves together with the IAB-node.

27. A non-transitory computer-readable storage medium storing instructions, wherein the instructions when executed by one or more processors of the terminal device cause the terminal device to perform the method for determining movement according to claim 1.
